(19) United States
(12) Patent Application Publication
(10) Pub. No.: US 2006/0224313 A1
(43) Pub. Date: Oct. 5, 2006

(54) Device for searching sub-facility included in facility

(75) Inventors: Yasuko Ohashi, Nagoya-city (JP); Katsumi Ohashi, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/370,947

(22) Filed: Mar. 9, 2006

(30) Foreign Application Priority Data
Mar. 31, 2005 (JP) 2005-100627
Jan. 20, 2006 (JP) 2006-012851

(51) Int. Cl. G01C 21/00

(52) U.S. Cl. 701/209; 701/200

(57) ABSTRACT

A searching device of the present invention searches a sub-facility included in a large compound facility based on information stored in the device. A large compound facility is first searched, and then a sub-facility included in the large compound is searched if a user specifies the sub-facility. The user may specify the sub-facility to be searched by inputting certain keywords even when he/she does not know the exact name of the sub-facility. The searching device may be advantageously included in a navigation system such as a car navigation system. The specified sub-facility included in a large compound facility may be set as a target destination and a driving route from a starting point to the target destination can be exactly calculated.

### CROSS-REFERENCE TO RELATED APPLICATION

This application is based upon and claims benefit of priority of Japanese Patent Applications No. 2005-100627 filed on Mar. 31, 2005 and No. 2006-12851, filed on Jan. 20, 2006, the content of which is incorporated herein by reference.

### BACKGROUND OF THE INVENTION

1. Field of the Invention

The present invention relates to a device for searching or locating a sub-facility included in a compound large facility and to a navigation system having such a searching device.

2. Description of Related Art

A navigation system disclosed in JP-A-2003-344078 includes a searching device that is able to search facilities located in the vicinity of a specified facility. It is not possible, however, to search sub-facilities included in a large facility such as a shopping mall or a compound playground. A large compound facility often includes a sub-facilities such as small specialty shops, movie theaters, or the like. The conventional navigation system has been impossible to locate such sub-facilities included in a large facility. However, a user sometimes wants to locate an exact position of a sub-facility to park at a position close to the sub-facility in a large compound.

### SUMMARY OF THE INVENTION

The present invention has been made in view of the above-mentioned problem, and an object of the present invention is to provide a device for searching a sub-facility included in a large compound facility. Another object of the present invention is to provide a navigation system having such a searching device.

There are large compound facilities, each of which includes sub-facilities such as a shopping mall, movie theaters, playgrounds, small specialty shops, parking spaces and so on. The searching device according to the present invention searches a sub-facility specified by a user based on stored information regarding the large compound facilities (referred to as facilities) and sub-facilities belonging to or included in respective facilities. First, the facility specified by a user is searched. Then, whether or not a sub-facility or sub-facilities are included in the specified facility is checked. If at least one sub-facility is included in the specified facility, a sub-facility to be searched is specified by the user.

The sub-facility may be searched according to keywords inputted by the user. The keywords may include a name, a location, a genre, a telephone number or the like of the sub-facility to be searched. If the user does not know the name of the sub-facility, the sub-facility may be searched based on keywords other than the name. When the specified sub-facility is found, it may be shown on a map display.

The searching device of the present invention is advantageously included in a navigation system such as a car navigation system. The specified compound facility may be first set as a target destination, and if a sub-facility is specified and found in the compound facility, the sub-facility is set as the target destination, replacing the compound facility first set as the target destination. A driving route from a starting point to the target destination is calculated, and a driver is guided to the target destination.

Further, a parking space or a parking lot closest to the specified sub-facility included in the facility may be set as the target destination. Not only the specified sub-facility is exactly located but the closest parking lot can be pinpointed. The navigation system of the present invention guides a driver exactly to the sub-facility specified by the driver, while a conventional navigation system guides a driver only to the large compound facility.

Other objects and features of the present invention will become more readily apparent from a better understanding of the preferred embodiment described below with reference to the following drawings.

### BRIEF DESCRIPTION OF THE DRAWINGS

FIG. 1 is a block diagram showing a navigation system for an automotive vehicle according to the present invention;

FIG. 2 is a flowchart showing a process of searching a sub-facility included in a facility according to the present invention;

FIG. 3 is an example of a display showing parking lots in a parking space and distance to an entrance of a sub-facility; and

FIG. 4 is a flowchart showing a process of generating a display shown in FIG. 3.

### DETAILED DESCRIPTION OF THE PREFERRED EMBODIMENT

A preferred embodiment of the present invention will be described with reference to accompanying drawings. The present invention is applied to a car navigation system, and more particularly to a device included in the navigation system for searching a sub-facility included in a compound facility.

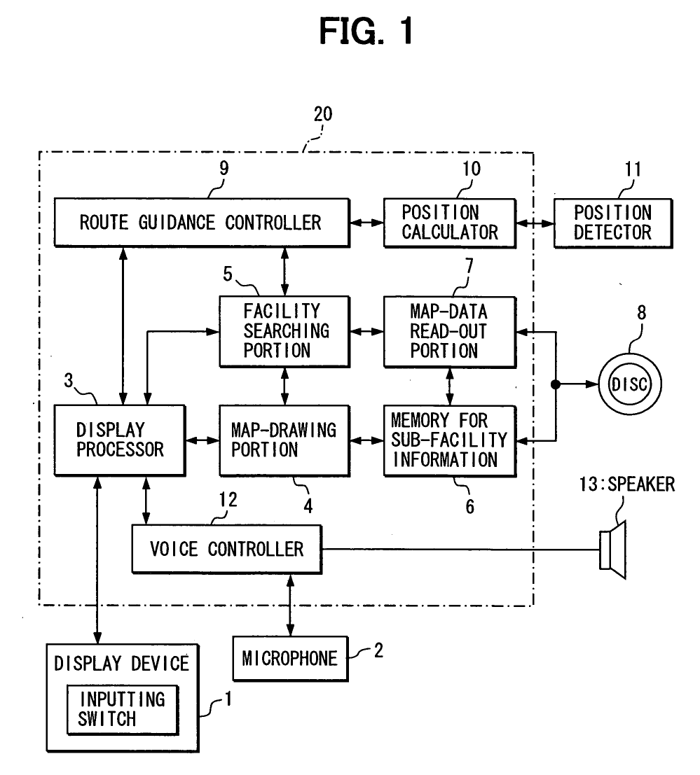

As shown in FIG. 1, the navigation system is composed of a display device 1, a microphone 2, a map disc 8, a position detector 11, a speaker 13, and a controller 20 connected to those components. The controller 20 is a conventional computer including ROM, RAM, I/O and bus lines. The controller 20 performs predetermined processes such as a process for searching a facility, a process for setting a target destination, a process for calculating a driving route and a process for guiding a driver.

The display device 1 displays various images thereon such as maps and a chart for setting a desired destination. The display device 1 includes a full color liquid crystal display panel or an electroluminescent display panel and touch switches formed integrally with the display panel or mechanical switches. A user inputs various commands to the controller 20 by operating the switches of the display device 1. Voices of a user are fed to the microphone 2 that converts the voices into electrical signals to be fed to a voice controller 12 included in the controller 20. The speaker 13 outputs voices for giving route guidance to a driver, for explaining how to inputs commands or the like, based on output signals from the controller 20.

The position detector 11 includes a GPS (Global Positioning System) receiver that detects a present position of a vehicle based on signals fed from a magnetic sensor, a gyro-sensor, a distance sensor and satellites. These sensors are used in combination to compensate or minimize errors included in respective sensors. The position of the vehicle may be detected by some of these sensors, or some other sensors such as a vehicle speed sensor and a steering wheel sensor may be additionally used.

The map disc 8 is a memory device in which map data including road network information and facility information are stored. The map disc 8 is contained in a map data container device. Various data are sent out from the map data container according to requests from the controller 20. A CD-ROM or a DVD-ROM is used as the memory device for storing various data. Alternatively, rewritable memory devices such as a memory card or a hard disc may be used as the memory device.

Now, road network information including link information and node information and facility information will be explained. Roads on the map are divided by plural nodes that include intersections, branches and flow-in points, and each node is connected to another node through a link. The link information includes a link ID number, a length of a link, coordinate (latitude and longitude) of nodes at both ends of a link, a name of a road, types of a road (expressway, pay road, state highway, community road or the like), a width of a road, a period of time required for traveling a link by car or on foot. The node information includes a node ID number, coordinate (latitude and longitude) of a node, IDs of all the links connected to a node.

The facility information includes a name, a type or a kind, an address and a location (latitude and longitude) of a facility. If a facility is a large compound facility such as a shopping mall or a large-scale playing ground that includes sub-facilities such as many other small shops and associated buildings or places, information concerning those sub-facilities is also included in the facility information as information connected to that compound facility. The information concerning the sub-facilities is referred to as sub-facility information.

The sub-facility information includes a name, a genre (movie, restaurant, pet shop or the like), a position (coordinate) of a representative point, a position of an entrance/exit, and a telephone number of each sub-facility. The sub-facility information further includes information concerning a parking space of a large compound to which the sub-facility is included. The information concerning the parking space includes a position of a representative point, space arrangement, positions of passages, polygon information for describing a total layout, and a capacity of the parking place. The position of a place means its coordinate on a map (latitude and longitude).

As shown in FIG. 1, the controller is composed of a display processor 3, a map-drawing portion 4, a facility searching portion 5, a memory for sub-facility information 6, a map data read-out portion 7, a route guidance controller 9, a position calculator 10, and a voice controller 12. The display processor 3 processes signals fed from the map-drawing portion 4, the facility searching portion 5, the route guidance controller 9 and the voice controller 12 to display images on the display device 1. The map-drawing portion 4 generates image data to be displayed on the display panel 1. The facility searching portion 5 performs a process for searching the facilities based on the map data read out by the map data read-out portion 7.

The memory 6 for sub-facility information stores information fed from the map disc 8. The route guidance controller 9 calculates a driving route from a starting point to a target destination and performs a route guiding process based on the vehicle position fed from the position calculator 10. The voice controller 12 generates a voice command to be fed to the display controller 3 based on voices fed from the speaker 13. The voice command is generated by comparing the input voice with vocabulary stored in a dictionary and by picking up a word that has the highest similarity with the input voice. The voice controller 12 generates voice data to be answered-back to a user through the speaker 13.

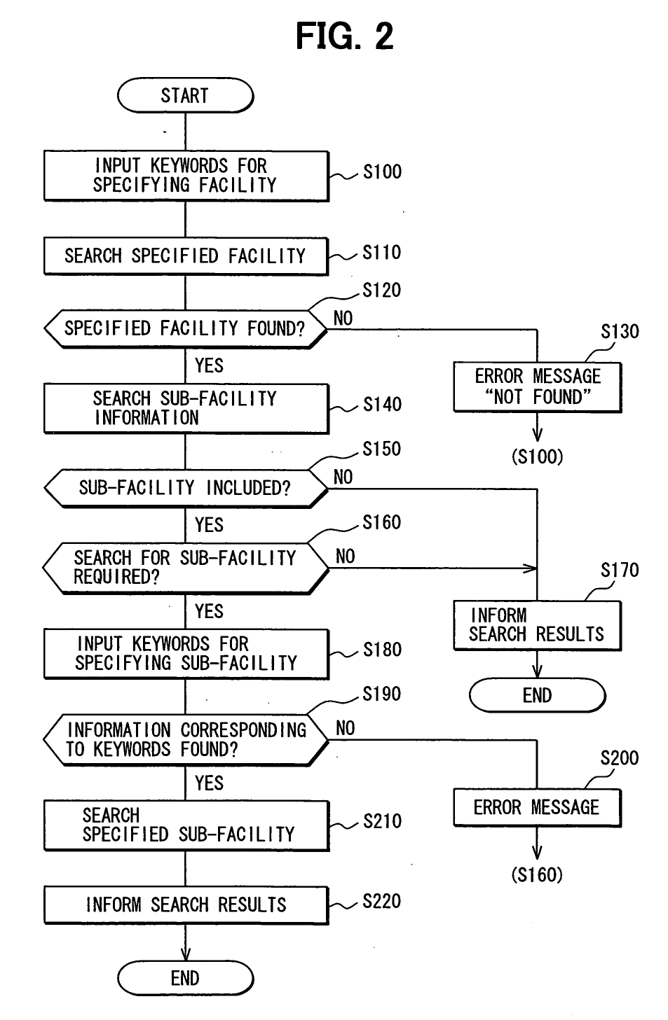

Now, with reference to FIG. 2, a process of searching a sub-facility included in a compound facility will be described. The sub-facility searched is set as a target destination in the navigation system. At step S100, keywords for specifying a facility to be searched are inputted. The keywords may include a name, a genre, an address, a telephone number of the facility. The keywords may be inputted through a keyboard of the inputting switch 1 or the microphone 2. At step S110, the specified facility is searched using the facility information included in the map data. If plural facilities are found, one facility may be selected through a preset selecting process, or a user may select one facility from among the plural facilities.

At step 120, whether or not the specified facility is successfully searched is determined. If the specified facility is successfully searched, the specified facility (referred to as a facility A) is set in the navigation system as a target destination. If not, the process proceeds to step S130, where an error message such as “the specified facility is not found” is shown on the display or announced through the speaker. Then, the process returns to step S100, where the user may input again data for searching a facility.

At step S140, sub-facilities included in the specified facility A are searched with reference to the map data. At step S150, whether or not a sub-facility or sub-facilities are included in the specified facility A is determined. If the sub-facility or facilities are not found in the facility A, the process proceeds to step S170, where it is informed to the user that no sub-facilities are included in the facility A, and it is confirmed if the user wishes to set the specified facility A as a target destination. If the user confirms it, the facility A is set as the target destination, and the process comes to the end. The target destination is set to a representative spot in the facility A. A driving route to the facility A is calculated through a route calculation process in the navigation system. If the user does not want to set the facility A as the target destination, the process returns to step S100 to repeat the steps described above.

If it is determined that the sub-facility or facilities are found in the facility A at step S150, the process proceeds to step S160, where the user is asked whether he/she wants to search a sub-facility. If the user wants to search a sub-facility, the process proceeds to step S180, where the user is requested to specify the sub-facility to be searched. The user inputs keywords necessary to specify the sub-facility (the specified sub-facility is referred to as Aa). If the user does not want to search the sub-facility, the process proceeds to step S170.

At step S190, whether information concerning the specified sub-facility Aa is included in the stored information is determined. If the information is included, the process proceeds to step S210, where the sub-facility Aa is searched on the map. If not, the process proceeds to step S200, where an error message such as “the specified sub-facility is not found in the facility A” is given to the user. Then, the process proceeds to step S160 to repeat above-steps again. At step S220, the search results are informed to the user, and the process comes to the end. In the navigation system, the specified sub-facility Aa is set as the target destination. Since the facility A has been set as the target destination at step S120, the target destination is reset to the sub-facility Aa. In the case where a parking space is included in the compound facility A, the target destination may be set to a parking lot closest to the sub-facility Aa. The navigation system calculates a driving route from the starting point to the target destination Aa.

As described above, a sub-facility can be searched even when the user does not know the exact name of the sub-facility Aa included in a large compound facility A by inputting keywords indicating a genre such as movie, restaurant or pet shop, for example. If plural sub-facilities are found based on the inputted keywords, it is preferable to inform the user of the sub-facilities according to a predetermined preference order. In this manner, a user who wants to see a movie at a movie theater Aa included in a large compound facility A is guided to the parking spot closest to the movie theater Aa. In a conventional navigation system, the user is guided only to the large compound A.

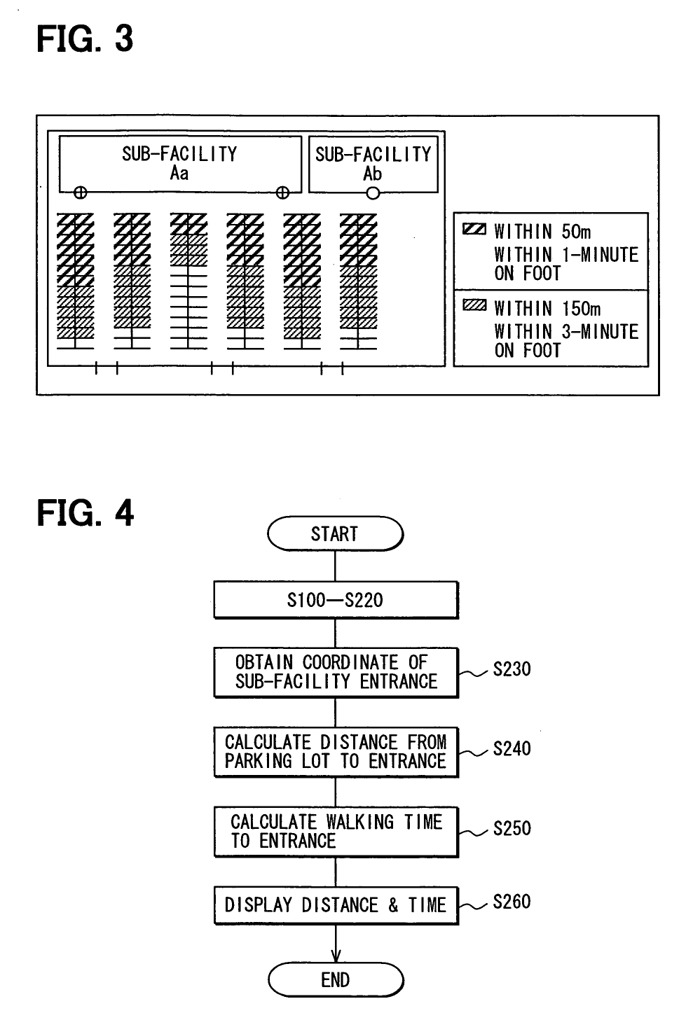

The searching device described above may be modified to further include additional functions described below. For example, a layout of the parking space closest to the sub-facility Aa may be displayed on the display panel, as shown in FIG. 3. The display example shown in FIG. 3 includes another sub-facility Ab in addition to the sub-facility Aa. It also includes a distance and a walking time from each parking lot to the closest entrance/exit of the sub-facility Aa.

The process of searching a sub-facility Aa included in a facility A performed in this modified form is shown in FIG. 4. Steps S100-S220 are the same as those shown in FIG. 2, and steps S230-S260 are added. At step S230, when a parking lot closest to the sub-facility Aa is set as the target destination, a coordinate of an entrance/exit is obtained from the sub-facility information. Then, at step S240, a distance from each parking lot to the entrance/exit is calculated based on the coordinate of the entrance/exit, coordinates of each parking lot and passages, and arrangement of the parking lots. Then, at step S250, a walking time from each parking lot to the entrance/exit is calculated, assuming that a person walks 50 meters per minute, for example. Then, at step S260, the parking lots are classified into two groups, a first group positioned within 50 m (one-minute walk) to the entrance/exit and a second group positioned within 150 m (three-minute walk), and the picture image as shown in FIG. 3 is displayed on the display panel. In this manner, the user is properly guided to the parking lot closest to the specified sub-facility Aa.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A device for searching a sub-facility included in a facility, comprising:
memory means for memorizing facility information and sub-facility information;
means for searching a specified facility using the facility information;
means for determining whether the specified facility searched by the searching means includes a sub-facility or sub-facilities; and
means for searching a specified sub-facility using the sub-facility information, when the determining means determines that the specified facility includes at least one sub-facility.

2. The searching device as in claim 1, wherein:
the sub-facility information includes at least one of a name, a genre, a location and a telephone number of each sub-facility as a searching keyword; and
the specified sub-facility is searched by using the searching keyword.

3. The searching device as in claim 1, further including means for informing a user that a sub-facility or sub-facilities are included in the specified facility when the determining means so determines.

4. The searching device as in claim 1, further including means for informing a user that the specified sub-facility is included in the specified facility when the means for searching a specified sub-facility finds that the specified sub-facility is included in the specified facility.

5. A navigation system comprising the searching device defined in claim 1 and means for setting either the specified facility or the specified sub-facility as a target destination.

6. The navigation system as in claim 5, wherein:
the setting means resets the target destination from the specified facility to the specified sub-facility when the specified facility is first set as the target destination and then the specified sub-facility is found in the specified facility.

7. The navigation system as in claim 5, wherein:
the sub-facility information includes information regarding parking spaces; and
the setting means sets a parking space in the vicinity of the specified sub-facility as the target destination.

8. The navigation system as in claim 7, wherein:
the sub-facility information includes a position of an entrance of a sub-facility, a representative position of the parking space, space and passage arrangements in the parking space; and
the navigation system further includes means for calculating either a distance or a walking time from a parking space to the entrance of the sub-facility based on the sub-facility information and means for informing a user either the distance or the walking time calculated by the calculating means.

9. The navigation system as in claim 5, further including means for calculating a route from a starting point to the target destination and means for guiding a user according to the route calculated by the calculating means.
